(19) United States
(12) Patent Application Publication
(10) Pub. No.: US 2014/0300125 A1
(43) Pub. Date: Oct. 9, 2014

(54) CENTER CONSOLE HAVING A ROTATING HOLDING UNIT

(71) Applicant: GM GLOBAL TECHNOLOGY OPERATIONS LLC, (US)

(72) Inventor: Gerard Brinas, Sterling Heights, MI (US)

(73) Assignee: GM GLOBAL TECHNOLOGY OPERATIONS LLC, Detroit, MI (US)

(21) Appl. No.: 13/858,153

(22) Filed: Apr. 8, 2013

(51) Int. Cl. B60R 7/04

(52) U.S. Cl. CPC B60R 7/04
USPC 296/24.34

(57) ABSTRACT

A trim assembly, such as a center console for a vehicle, includes a base portion, a cover portion and a holding unit. The cover portion defines a cover opening, and is attached to the base portion. The holding unit is disposed between the cover portion and the base portion, and is rotatably supported by the base portion for rotation about a rotation axis between a bin storage position and a cup-holder storage position. A bin storage position presents a bin aperture defined by a first side of the holding unit adjacent the cover opening to provide access to an open interior region of the holding unit through the cover opening for storage. A cup-holder storage position presents a cup aperture defined by a second side of the holding unit adjacent the cover opening to secure a cup within the interior region of the holding unit.

### TECHNICAL FIELD

The invention generally relates to a trim assembly for an interior of a vehicle, and more specifically to a center console of the vehicle.

### BACKGROUND

Interior trim assemblies of a vehicle often provide cup-holders for supporting a cup therein. Often, occupants may attempt to store small objects in the cup-holders, such as a mobile phone, a wallet, etc. Because the cup-holders are shaped and configured for supporting circular shaped cups, the cup-holders do not function well for storing other objects.

### SUMMARY

A center console for a vehicle is provided. The center console includes a support structure and a holding unit. The support structure defines a cover opening therethrough. The holding unit is attached to and rotatably supported by the support structure for rotation about a rotation axis. The holding unit rotates between a first storage position and a second storage position. The holding unit includes a first side presenting a first storage configuration adjacent to the cover opening when the holding unit is disposed in the first storage position. The holding unit includes a second side presenting a second storage configuration adjacent to the cover opening when the holding unit is disposed in the second storage position.

A console is also provided. The console includes a base portion, a cover portion and a holding unit. The cover portion defines a cover opening therethrough, and is attached to the base portion. The holding unit is disposed between the cover portion and the base portion. The holding unit is rotatably supported by the base portion for rotation about a rotation axis between a first storage position and a second storage position. The holding unit rotates ninety degrees (90°) about the rotation axis between the first storage position and the second storage position. The holding unit includes a first side, a second side, a third side and a fourth side. The first side and the third side are disposed opposite each other across the rotation axis, and the second side and the fourth side are disposed opposite each other across the rotation axis. The first side defines a bin aperture sized to approximate a size of the cover opening, and the third side defines a solid wall. The first side is disposed adjacent to the cover opening when the holding unit is disposed in the first storage position to provide bin storage. The second side defines a cup aperture sized to receive a cup therethrough and provide lateral support to the cup, and the fourth side includes a depression disposed opposite the cup aperture for supporting a bottom surface of the cup. The second side is disposed adjacent to the cover opening when the holding unit is disposed in the second storage position to provide a cup-holder.

Accordingly, the holding unit may be rotated by a user between the first storage position and the second storage position. If the user wishes to secure a cup within the holding unit, then the user may rotate the holding unit into the second storage position, i.e., the cup-holder storage position. If the user wishes to store small objects within the holding unit, then the user may rotate the holding unit into the first storage position, i.e., the bin storage position.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic exploded perspective view of a trim assembly.

FIG. 2 is a schematic cross sectional view of the trim assembly perpendicular to a rotation axis showing a holding unit in a first storage position.

FIG. 3 is a schematic cross sectional view of the trim assembly perpendicular to the rotation axis showing the holding unit in a second storage position.

FIG. 4 is a schematic cross sectional view of the trim assembly perpendicular to the rotation axis showing a rotatable connection between a base portion of the trim assembly and the holding unit.

FIG. 5 is a schematic cross sectional view of the trim assembly parallel with the rotation axis showing the holding unit in the second storage position and the rotatable connection between the base portion and the holding unit.

FIG. 6 is a schematic fragmentary cross sectional view of the trim assembly perpendicular to the rotation axis showing an enlarged view of the rotatable connection between the base portion and the holding unit.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

Referring to the Figures, wherein like numerals indicate like parts throughout the several views, a trim assembly is generally shown at 20. As shown in the Figures, the trim assembly 20 is configured as a center console for a vehicle. However, it should be appreciated that the trim assembly 20 may be configured in some other manner, such as a fold-down arm rest, door panel, etc.

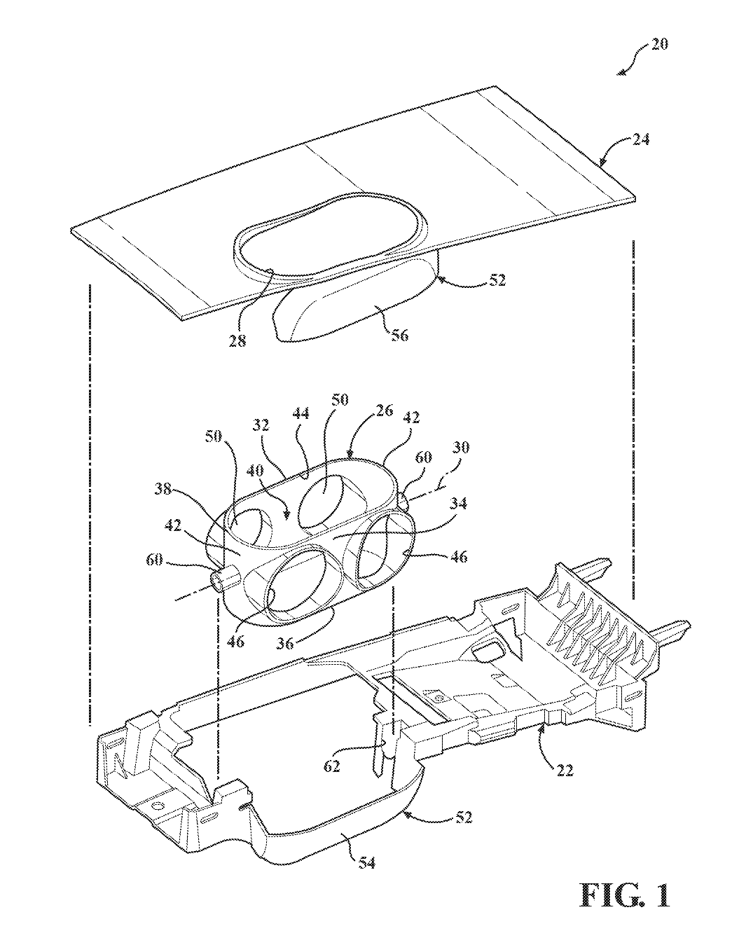

Referring to FIG. 1, the trim assembly 20 includes a support structure comprised of a base portion 22 and a cover portion 24. The trim assembly 20 further includes a holding unit 26. The base portion 22 supports both the cover portion 24 and the holding unit 26, and is configured for attachment to the vehicle. The cover portion 24 is attached to the base portion 22, and presents the outer, visible portion of the trim assembly 20. The cover portion 24 may be attached to the base portion 22 in any suitable manner, including but not limited to a snap fit connection, or attached via a plurality of fasteners. The cover portion 24 defines a cover opening 28 that extends through the cover portion 24. The cover opening 28 is defined by a substantially horizontally positioned top surface of the cover portion 24.

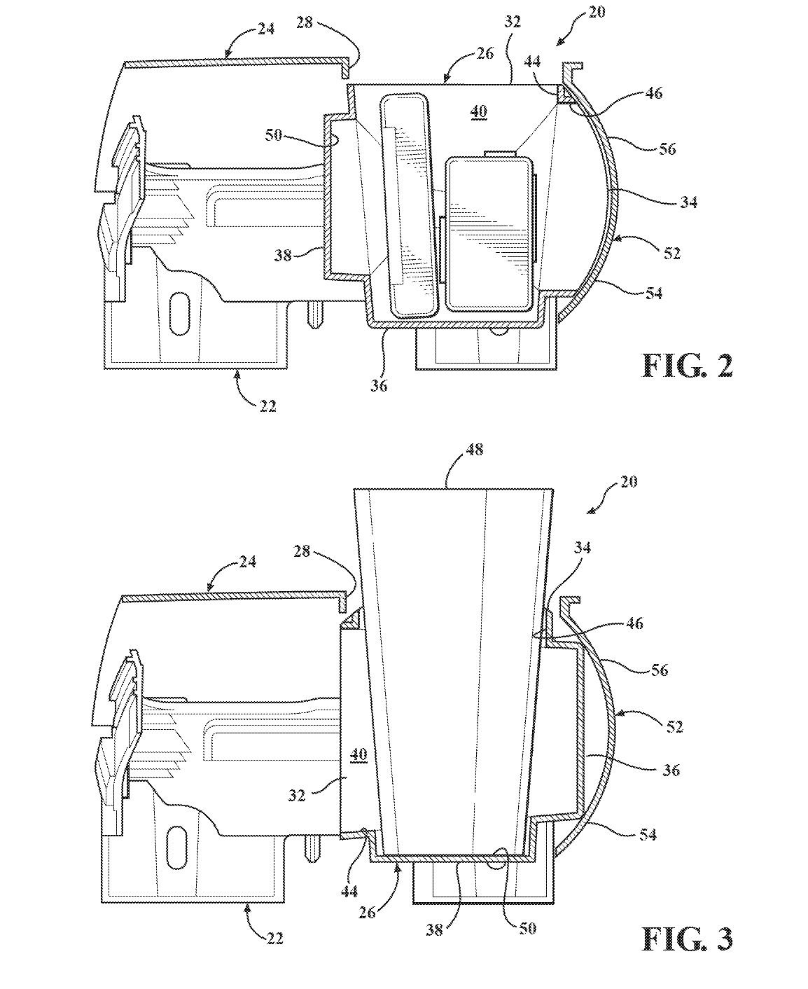

The holding unit 26 is disposed between the cover portion 24 and the base portion 22. The base portion 22 and the cover portion 24 cooperate to constrain the holding unit 26 in place therebetween. The holding unit 26 is rotatably supported by the base portion 22 of the support structure for rotation about a rotation axis 30. The holding unit 26 rotates back and forth ninety degrees (90°) about the rotation axis 30 between a first storage position, shown in FIG. 2, and a second storage position, shown in FIG. 3.

Referring to FIGS. 1 through 3, the holding unit 26 includes a first side 32, a second side 34, a third side 36 and a fourth side 38. The first side 32 and the third side 36 are disposed opposite each other across the rotation axis 30. The second side 34 and the fourth side 38 are disposed opposite each other across the rotation axis 30. The holding unit 26 defines an open interior region 40 that is laterally bounded by the first side 32, the second side 34, the third side 36 and the fourth side 38 of the holding unit 26. The interior region 40 is bounded at each axial end along the rotation axis 30 by an end wall 42.

When the holding unit 26 is disposed in the first storage position, the first side 32 of the holding unit 26 presents a first storage configuration adjacent to the cover opening 28. As shown in the Figures, the first storage configuration may be referred to as a bin storage configuration suitable for storing miscellaneous items, such as but not limited to mobile phones, small cameras, pens, etc. The first side 32 of the holding unit 26 defines a bin aperture 44 that is sized to approximate a size of the cover opening 28. When the holding unit 26 is positioned in the first storage position, with the first side 32 adjacent the cover portion 24, the bin aperture 44 provides access to the interior region 40 of the holding unit 26 through the cover opening 28 for storing miscellaneous items. The bin aperture 44 includes substantially the same size and shape as the cover opening 28 so that the first side 32 of the holding unit 26 does not restrict or limit the shape and size of the cover opening 28. As such, the first side 32 of the holding unit 26, when positioned adjacent the cover opening 28 in the first storage position, does not inhibit placement of objects into the interior region 40 of the holding unit 26. The third side 36 of the holding unit 26 defines a solid wall. When the holding unit 26 is disposed in the first storage position, the solid wall of the third side 36 defines the bottom surface of the holding unit 26.

The second side 34 of the holding unit 26 defines at least one cup aperture 46. As shown, the second side 34 defines two cup apertures 46; however, it should be appreciated that the second side 34 may define more than two cup apertures 46. Each cup aperture 46 includes a circular shape sized to receive a bottom portion of a cup 48 therethrough. When the holding unit 26 is positioned in the second storage position, with the second side 34 adjacent the cover portion 24, each of the cup apertures 46 provides access to the interior region 40 of the holding unit 26 through the cover opening 28 for supporting and securing the cup 48 within the interior region 40 of the holding unit 26. The fourth side 38 of the holding unit 26 includes at least one depression 50. Each of the depressions 50 is disposed opposite one of the cup apertures 46. Each of the depressions 50 extends outward away from the rotation axis 30, and is sized and shaped for supporting the bottom portion of the cup 48. Accordingly, when the holding unit 26 is positioned in the second storage position, each cup aperture 46, and the depression 50 disposed opposite thereof, cooperate to provide lateral support to the cup 48.

At least one of the base portion 22 and the cover portion 24 includes a sidewall 52. The sidewall 52 extends substantially vertically, in an approximate perpendicular angle relative to the top surface of the cover portion 24. The sidewall 52 is disposed adjacent the holding unit 26, and is positioned to close or block an aperture defined by one of the first side 32 or the second side 34 of the holding unit 26, when either the first side 32 or the second side 34 are not disposed adjacent the cover opening 28 of the cover portion 24. For example and as shown, when the holding unit 26 is disposed in the first storage position with the first side 32 disposed adjacent the cover opening 28 and the second side 34 disposed adjacent a right edge of the trim assembly 20 as viewed in FIG. 2, the sidewall 52 closes or blocks the apertures defined by the second side 34 of the holding unit 26, i.e., the cup apertures 46. While not specifically shown in the Figures, it should be appreciated that the sidewall 52 may be positioned to the left of the cover opening 28 as viewed in FIG. 3 to close or block the bin aperture 44 of the first side 32 when the holding unit 26 is disposed in the second storage position. Referring to FIG. 1, the base portion 22 includes a first sidewall section 54, and the cover portion 24 includes a second sidewall section 56. As shown in FIGS. 2 and 3, the first sidewall section 54 and the second sidewall section 56 engage each other when the cover portion 24 is attached to the base portion 22 to form the complete sidewall 52. Alternatively, it should be appreciated that the entire sidewall 52 may be formed by either the base portion 22 or the cover portion 24.

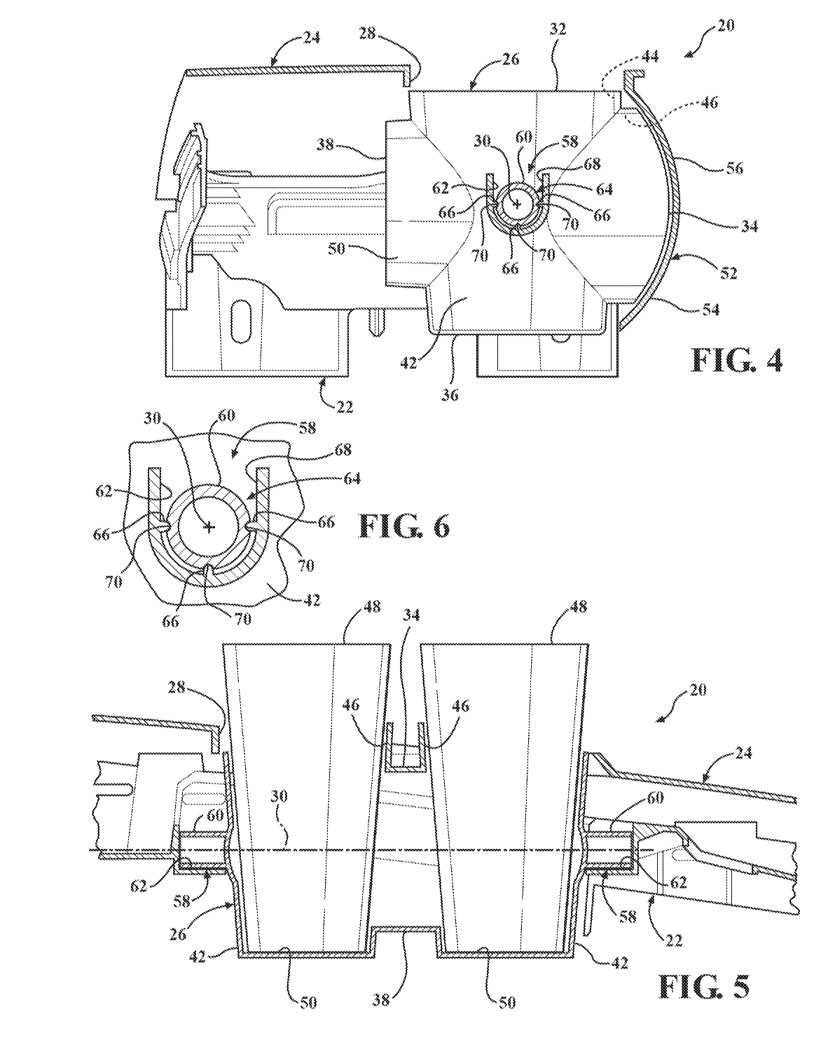

Referring to FIGS. 4 and 5, the trim assembly 20 includes a rotatable connection 58 that interconnects the holding unit 26 and the base portion 22, and allows the holding unit 26 to rotate about the rotation axis 30. As shown, the rotatable connection 58 includes a support cylinder 60 attached to each end wall 42 of the holding unit 26. Each support cylinder 60 extends outward away from the holding unit 26 along the rotation axis 30. The support cylinders 60 include a cylindrical shape defining a circular cross section perpendicular to the rotation axis 30. The support cylinders 60 are concentrically located about the rotation axis 30. The base portion 22 includes a support slot 62 for each support cylinder 60. Each support slot 62 extends along the rotation axis 30, and includes a semi-circular cross section perpendicular to the rotation axis 30 configured for receiving the support cylinders 60 therein. Each of the support slots 62 rotatably supports one of the support cylinders 60, such that the support cylinders 60 rotate within the support slots 62.

Referring to FIGS. 4 and 5, the rotatable connection 58 includes a detent system 64. The detent system 64 releasably secures the holding unit 26 in either the first storage position or the second storage position. As shown, the detent system 64 includes at least one ridge 66, and preferably multiple ridges 66, disposed on an interior surface 68 of the support slot 62, and extending axially along the rotation axis 30. The ridges 66 engage the support cylinder 60 in frictional engagement to restrict relative movement therebetween. Preferably, the detent system 64 includes a plurality of channels 70 recessed into the support cylinder 60. The channels 70 extend axially along the rotation axis 30. The channels 70 on the support cylinders 60 are sized and shaped to receive the ridges 66 in the support slot 62 therein. When the holding unit 26 is positioned in either the first storage position or the second storage position, the ridges 66 and the channels 70 are configured to nest together to provide resistance against rotation, thereby securing the position of the holding unit 26 relative to the base portion 22 and the cover portion 24. Upon application of sufficient force to the holding unit 26, the nesting engagement between the ridges 66 and channels 70 is broken, allowing the holding unit 26 to rotate. Upon reaching the other of the first storage position or the second storage position, the ridges 66 and the plurality of channels 70 are positioned such that they once again nest together. Accordingly, it should be appreciated that the ridges 66 nest with one of the channels 70 when the holding unit 26 is in either the first storage position or the second storage position. It should be appreciated that the rotatable connection 58 and the detent system 64 may be configured differently than shown and described herein.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A center console for a vehicle, the center console comprising:
a support structure defining a cover opening therethrough; and
a holding unit attached to and rotatably supported by the support structure for rotation about a rotation axis between a first storage position and a second storage position;
wherein the holding unit includes a first side presenting a first storage configuration adjacent to the cover opening when the holding unit is disposed in the first storage position; and
wherein the holding unit includes a second side presenting a second storage configuration adjacent to the cover opening when the holding unit is disposed in the second storage position.

2. A center console as set forth in claim 1 further comprising a rotatable connection interconnecting the holding unit and the support structure.

3. A center console as set forth in claim 2 wherein the rotatable connection includes a support cylinder attached to the holding unit and extending outward away from the holding unit along the rotation axis, wherein the support cylinder is concentrically located about the rotation axis.

4. A center console as set forth in claim 3 wherein the support structure includes a base portion and a cover potion attached to the base portion, with the cover portion defining the cover opening.

5. A center console as set forth in claim 4 wherein the rotatable connection includes a support slot defined by the base portion, with the support cylinder rotatably supported within the support slot.

6. A center console as set forth in claim 5 wherein the rotatable connection includes a detent system securing the holding unit in either the first storage position or the second storage position.

7. A center console as set forth in claim 6 wherein the detent system includes at least one ridge extending axially along the rotation axis and disposed on the support slot in frictional engagement with the support cylinder.

8. A center console as set forth in claim 7 wherein the detent system includes at least one channel extending axially along the rotation axis and recessed into the support cylinder for receiving the at least one ridge on the support slot therein when the holding unit is disposed in either the first storage position or the second storage position.

9. A center console as set forth in claim 3 wherein the holding unit includes an end wall disposed at an axial end of the holding unit along the rotation axis, with the support cylinder extending outward from the end wall along the rotation axis.

10. A center console as set forth in claim 1 wherein the holding unit further includes a third side and a fourth side, with the first side and the third side disposed opposite each other across the rotation axis, and the second side and the fourth side disposed opposite each other across the rotation axis.

11. A center console as set forth in claim 10 wherein the first side of the holding unit defines a bin aperture sized to approximate a size of the cover opening, such that the first storage configuration is defined as an open bin storage configuration.

12. A center console as set forth in claim 11 wherein the third side defines a solid wall.

13. A center console as set forth in claim 10 wherein the second side of the holding unit defines a cup aperture sized to receive a cup therethrough and provide lateral support to the cup, such that the second storage configuration is defined as a cup-holder storage configuration.

14. A center console as set forth in claim 13 wherein the fourth side of the holding unit includes a depression disposed opposite the cup aperture and extending outward away from the rotation axis for supporting a bottom surface of the cup.

15. A center console as set forth in claim 1 wherein the holding unit rotates about the rotation axis ninety degrees (90°) between the first storage position and the second storage position.

16. A center console as set forth in claim 4 wherein at least one of the base portion and the cover portion includes a sidewall for closing an aperture defined by the second side of the holding unit when the holding unit is disposed in the first storage position, or for closing an aperture defined by the first side of the holding unit when the holding unit is disposed in the second storage position.

17. A center console as set forth in claim 16 wherein the base portion includes a first sidewall section and the cover portion includes a second sidewall section, with the first sidewall section and the second sidewall section engage each other to form the sidewall.

18. A console comprising:
a base portion;
a cover portion defining a cover opening therethrough, and attached to the base portion; and
a holding unit disposed between the cover portion and the base portion, and rotatably supported by the base portion for rotation about a rotation axis between a first storage position and a second storage position;
wherein the holding unit rotates ninety degrees (90°) about the rotation axis between the first storage position and the second storage position;
wherein the holding unit includes a first side, a second side, a third side and a fourth side, with the first side and the third side disposed opposite each other across the rotation axis, and the second side and the fourth side disposed opposite each other across the rotation axis;
wherein the third side defines a solid wall, and the first side defines a bin aperture sized to approximate a size of the cover opening, with the first side disposed adjacent to the cover opening when the holding unit is disposed in the first storage position to provide bin storage; and
wherein the second side defines a cup aperture sized to receive a cup therethrough and provide lateral support to the cup, and disposed adjacent to the cover opening when the holding unit is disposed in the second storage position, and the fourth side includes a depression disposed opposite the cup aperture for supporting a bottom surface of the cup, such that the second storage position includes a cup-holder storage position.

19. A console as set forth in claim 18 wherein at least one of the base portion and the cover portion includes a sidewall for closing an aperture defined by the second side of the holding unit when the holding unit is disposed in the first storage position, or for closing an aperture defined by the first side of the holding unit when the holding unit is disposed in the second storage position, to retain objects within an interior region of the holding unit.

20. A trim assembly comprising:
a support structure defining a cover opening therethrough; and
a holding unit attached to and rotatably supported by the support structure for rotation about a rotation axis between a bin storage position and a cup-holder storage position;
wherein the bin storage position presents a bin aperture adjacent the cover opening to provide access to an open interior region of the holding unit through the cover opening for storage, and the cup-holder storage position presents a cup aperture adjacent the cover opening to secure a cup within the interior region of the holding unit.
